(19) United States
(12) Patent Application Publication
(10) Pub. No.: US 2005/0139563 A1
(43) Pub. Date: Jun. 30, 2005

(54) DEVICE AND METHOD FOR LIFTING OBJECTS IN A LIMITED HEADROOM AREA

(75) Inventors: Timothy C. Bonerb, Kansas City, MO (US); Sergey Vaysfligel, Lenexa, MO (US); Bahman Aghdaie, Kansas City, MO (US)

Correspondence Address: DECKER LAW OFFICE, 1 NEW HAMPSHIRE AVE., SUITE 125, PORTSMOUTH, NH, 03801, US

(73) Assignee: SHICK TUBE-VEYOR CORP., Kansas City, MO (US)

(21) Appl. No.: 10/904,165

(22) Filed: Oct. 27, 2004

Related U.S. Application Data
(60) Provisional application No. 60/514,967, filed on Oct. 28, 2003.

(51) Int. Cl. B66C 19/00

(52) U.S. Cl. 212/71

(57) ABSTRACT

The invention includes improvements in the device and method for lifting objects, such as bulk bags, in an area of a building with low headroom constraints. Among the many improvements of the hoist arrangement is a movable cart and frame assembly that is mounted to or between various I-Beam configurations of a hoist structure, such as a bulk bag unloader, so that the object being lifted can be raised higher under its overhead hoist frame. By reducing the height requirements of a standard hoist, which can often take up as much as 15″ to 24″ of space between the I-Beam and object being lifted (such as a bulk bag) a user may now use a taller bulk bag or other object with a greater capacity. In most states, highway trailers are limited to hauling a maximum load of approximately 44,000 pounds. The addition of 12″ to 24″ of extra lifting height can often be the difference between filling a bag to 2,000 pounds instead of a lesser amount such as 1,500 pounds. This difference is significant because it enables a vendor to ship 22—2,000 pound bags instead of 44—1,000 pound bags. Obviously, filling a bag to 2,000 pounds in capacity instead of something less will provide the vendor and user significant savings in bags, pallets, bag filling, trailer loading & unloading, storage and other handling costs. In addition to the space savings, this invention provides significant savings when using the invention with a standard hoist as compared with a more expensive “low-profile” hoist.

### BACKGROUND

1.) Field of Invention

This invention relates to improvements for lifting and handling objects, such as bulk bags, in limited headroom areas.

2.) Description of Related Art

As more and more bulk bag applications (and other types of processes that involve lifting and handling objects of varying height) are designed and installed for a wide variety of lifting applications, the need for improvements in the handling of raw materials are surely to result. One of the more vexing problems has been in finding a simple, economical and off-the-shelf type of hoist assembly that can be used for low headroom applications. This invention allows the use a standard hoist to be used for low headroom applications.

### SUMMARY

It is the object of the invention to locate the hoist to the side (and out of the way) of the object being lifted between the end of its chain and the I-Beam that the hoist is located on.

Another object of the invention is provide a simple hoist & frame assembly that will allow an existing, standard type of hoist arrangement to be easily and inexpensively be reconfigured for low headroom applications.

Another object of the invention is to provide a method to gain greater space between an object be lifted under an I-Beam structure and the platform that it must raise to or platform that it must rest on.

Yet another object of the invention is to secure the hoist between two I-Beams.

### BRIEF DESCRIPTION OF DRAWINGS

FIG. 1 is a detailed, side view of a bulk bag unloader with the hoist moved to the side so that it is not between the I-beam and object being lifted.

FIG. 2 is a detailed, side view of a bulk bag unloader using a side mounted hoist cart assembly to lift a bulk bag off of the floor and onto the unloader for discharging.

FIG. 3 is a detailed, side view of a bulk bag unloader using a side mounted hoist cart assembly to lift a bulk bag to its maximum height under the unloader's I-Beam.

FIG. 4 is a detailed, side view of a bulk bag unloader using a side mounted hoist cart assembly with a bulk bag moved laterally along the I-Beam to a location over the unloader's support tray.

FIG. 5 is a detailed, side view of a bulk bag unloader using a side mounted hoist cart assembly with a bulk bag lowered onto the unloader's support tray.

FIG. 6 is a detailed, side view of a bulk bag unloader with the hoist moved to the side so that it is not between the I-Beam and object being lifted.

FIG. 7 is a detailed, side view of a hoist carriage assembly and components whereby the hoist is located off to the side and clear of the object being lifted.

FIG. 8 is a side view of a bulk bag unloader using an inverted bag lift frame with a standard hoist and trolley assembly.

FIG. 9 is a detailed, front view of a hoist frame structure that utilizes two I-Beams with a hoist carriage and hoist placed between them that is equipped with a trolley assembly for low headroom applications.

FIG. 10 is a detailed, side view of a hoist frame that utilizes a twin I-Beam configuration and low profile hoist and carriage assembly.

FIG. 11 is a detailed front view of a standard hoist and trolley configuration that is equipped with an inverted bag lift frame.

FIG. 12 is a top view of an adjustable bag lift frame used for lifting bulk bags.

FIG. 13 is a detailed front view of the right half of a bulk bag attached to an inverted bag lift frame using a snap ring assembly.

FIG. 14 is a detailed front view of bag lift frame that is secured to the chain of hoist on the trolley carriage 32.

TABLE OF REFERENCE NUMBERS
Definition List 1

| Term | Definition |
|---|---|
| 20 | Unloader Frame |
| 21 | Top Frame Support |
| 22 | Corner Post(s) |
| 23 | I-Beam |
| 24 | Trolley Assembly |
| 25 | Hoist |
| 26 | Chain |
| 27 | I-Beam Brackets |
| 28 | Bag Frame |
| 29 | Bag |
| 30 | Chain Bag |
| 31 | Trolley Motor |
| 32 | Hoist Cart |
| 33 | Wheel(s) |
| 34 | Hoist Frame |
| 35 | Hoist Anchor Pin |
| 36 | Hoist Frame Flange |
| 37 | Chain Wheel |
| 38 | Limit Switch |
| 39 | Chain Hook/Support Bracket |
| 40 | Chain Wheel(s) |
| 41 | Proximity Switch Bracket |
| 42 | Proximity Switch |
| 43 | Bag Frame End Flange(s) |
| 44 | End Flange Hole(s) |
| 45 | Posts |
| 46 | Lock Pin(s) |
| 47 | Bracing Supports |
| 48 | Snap Ring(s) |
| 50 | Floor |
| 85 | Support Tray |
| 86 | Cross Beam Support(s) |

### DETAILED DESCRIPTION OF DRAWINGS

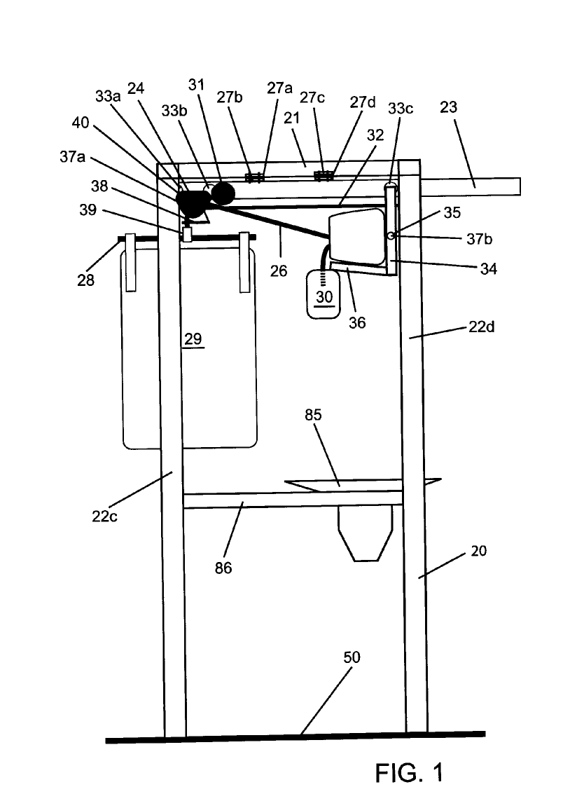

FIG. 1 is a side view of bulk bag unloader 20 with I-Beam 23 secured to top frame support 21. I-Beam 23 may be permanently welded to unloader frame 20 or bolted to top frame support 21 by using I-Beam brackets 27a, 27b, 27c and 27d. By welding I-Beam brackets 27a and 27c to top frame support 21 and I-Beam brackets 27b and 27d to I-Beam 23, I-Beam 23 may be secured to top frame 21 when I-Beam brackets 27a and 27b and I-Beam brackets 27c and 27d are bolted together respectively. Trolley assembly 24, which typically holds hoist 25 via anchor pin 37b, is mounted to I-beam 23 in the same manner as for normal hoist operation. Hoist cart 32 comes complete as a single unit with hoist frame 34, hoist frame flange 36, hoist anchor bracket 35 and wheel(s) 33c (and 33d—not shown). Hoist cart 32 is mounted to I-Beam 23 by placing wheels 33c and 33d (not shown) that are secured to top ends of hoist frame 34 over I-Beam 23. The other end of hoist cart 32 is secured to trolley assembly 24 via anchor pin 37a. As trolley assembly 24 and trolley motor 31 moves along I-Beam 23, hoist cart moves with it. Hoist 25 is mounted on its side and secured to hoist frame 34 via hoist anchor bracket 35 with anchor pin 37b. Hoist frame flange holds hoist 25 in a static and horizontal position so that when tension on chain 26 is reduced or eliminated that hoist will stay in a fixed position.

Although the term “wheels” is used frequently in this specification, it merely describes the preferred embodiment. The term “wheels” 33 can be any low-friction device or rotating means including, but not limited to, wheels, slides, and skids. And although the term “chain” is used frequently in this specification, it also merely describes the preferred embodiment. The “chain” 26 can be any tension-bearing element including, but not limited to, chain, cable, rope, strap, and wire rope.

If hoist 25 were allowed to rotate on anchor pin 37b and rotate downward, damage to hoist 25, chain 26 and hoist cart 32 may occur. To guide chain 26 from hoist 25 on a horizontal direction to a position under trolley assembly 24 and over bulk bag 29, chain wheel 40 is mounted to hoist cart 32 at or near anchor pin 37a. Typically, hoist 25 comes from the manufacturer, pre-wired with a safety switch to stop chain 26 movement as chain hook 39 moves against bottom of hoist 25. Limit switch 38 is mounted to hoist cart 32 under chain wheel 40 so the lifting operation of hoist 25 will stop as chain hook 39 presses against it. Hoist 25 is mounted away from the area under trolley assembly 24 so that bulk bag 29, bag frame 28 can be lifted as close to I-Beam 23 as possible. Chain bag 30 may be secured to hoist 25 collect chain 26b as hoist 25 is used in the lift mode. Bulk bag 29 may now be made larger to hold a greater capacity and still fit between support tray 85, mounted on cross beam supports 86, and I-Beam 23.

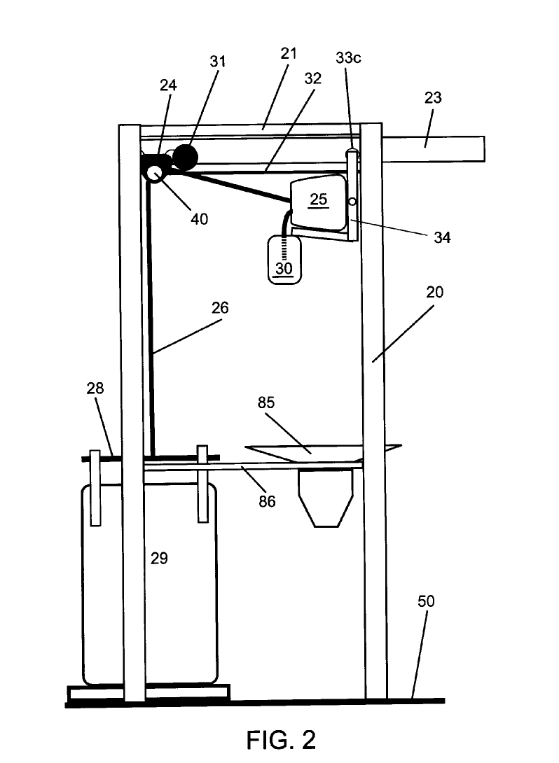

FIG. 2 is a side view of bulk bag unloader 20 with bag 29 positioned on a floor ready to be lifted for placement on support tray 85 for unloading. Hoist 25 is mounted on its side to hoist frame 34 and is located approximately 30″ to the side of chain wheel 40. Chain wheel 40 and hoist 25 are secured to hoist cart 32 so that as trolley assembly 24 and trolley motor 31 moves along I-Beam 23, the distance between chain wheel 40 and hoist 25 is fixed.

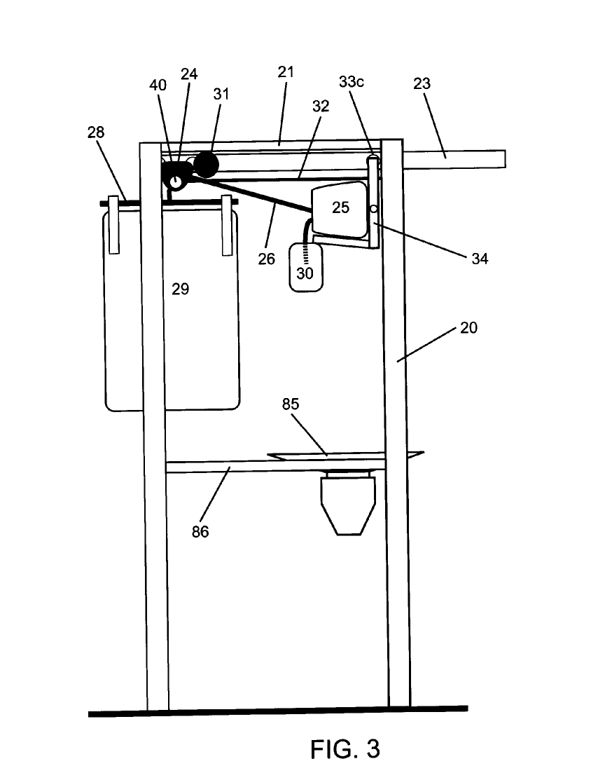

FIG. 3 is a side view of bulk bag unloader 20 with bag 29 lifted to its maximum height (within a few inches) under I-Beam 23 and top frame support 21.

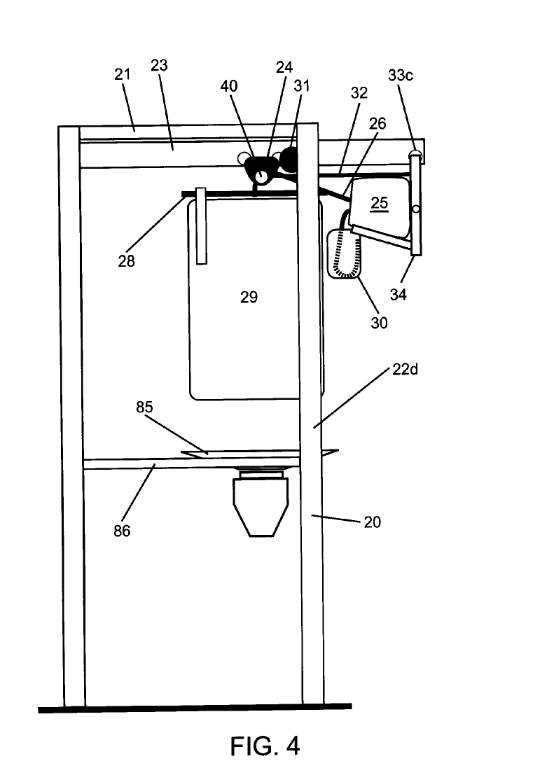

FIG. 4 is a front view of bulk bag unloader 20 with bag 29 moved laterally across I-Beam 23 over bag tray 85. As bulk bag 29 is moved over bag tray 85, which is supported on cross member(s) of unloader frame 20, hoist cart 32 and hoist 25 move to end of I-Beam 23. Typically, I-Beam 23 extends out from corner post 22d of unloader frame 20 a distance from the center opening of bag tray 85 and end of hoist cart 32 to a point at approximately the location of wheel 33c on hoist frame 34.

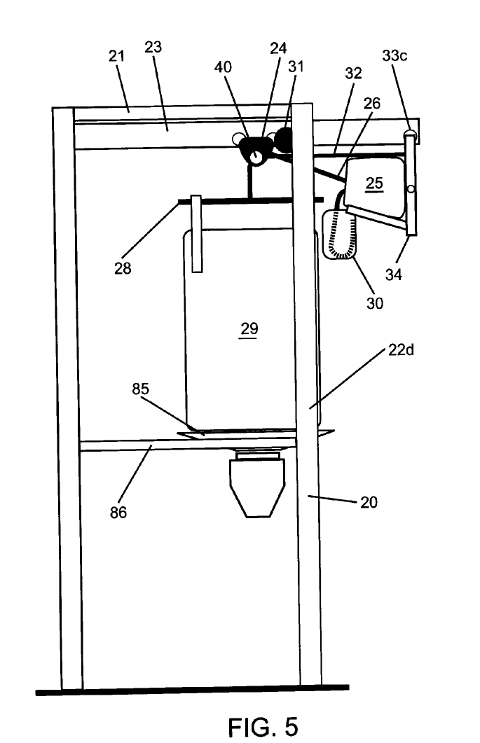

FIG. 5 is a side view of bulk bag unloader 20 with bag 29 lowered onto bag tray 85 so that bag 29 can be discharged. As bag 29 is lifted from floor, excess chain 26 will collect in chain bag 30 that is secured to hoist 25.

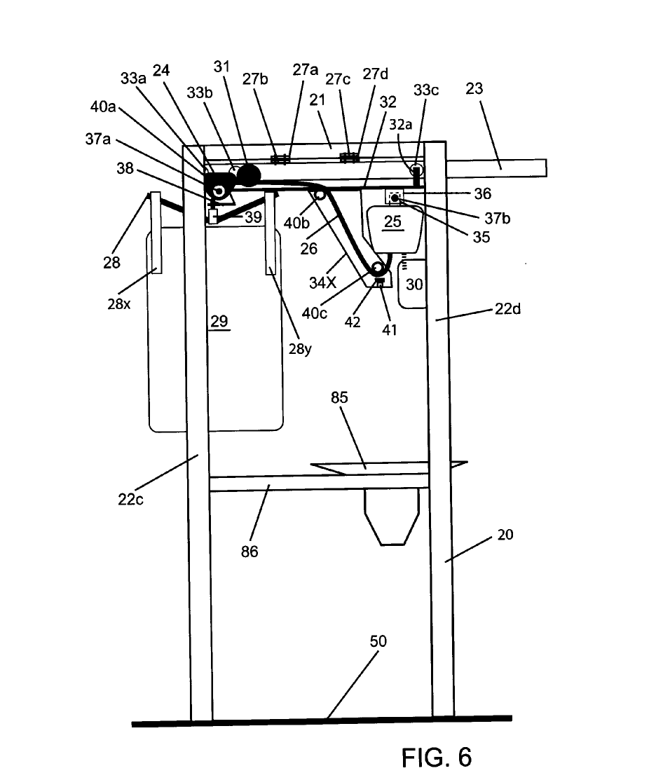

FIG. 6 is a side view of bulk bag unloader 20 with I-Beam 23 secured to top frame support 21. I-Beam 23 may be permanently welded to unloader frame 20 or bolted to top frame support 21 by using I-Beam brackets 27a, 27b, 27c and 27d. By welding I-Beam brackets 27a and 27c to top frame support 21 and I-Beam brackets 27b and 27d to I-Beam 23, I-Beam 23 may be secured to top frame 21 when I-Beam brackets 27a and 27b and I-Beam brackets 27c and 27d are bolted together respectively. Trolley assembly 24, which typically holds hoist 25 via anchor pin 37b, is mounted to I-Beam 23 in the same manner as for normal hoist operation. Hoist cart 32 comes complete as a single unit with hoist frame 34X, hoist frame flange 36, hoist anchor bracket 35 and wheel(s) 33c (and 33d—not shown). Hoist cart 32 mounts to I-Beam 23 by placing wheels 33c and 33d (not shown) that are secured to top ends of hoist frame 34 over I-Beam 23. The other end of hoist cart 32 is secured to trolley assembly 24 via anchor pin 37a. As trolley carriage 24 and trolley motor 31 moves along I-beam 23, hoist cart 32 moves with it. Hoist 25 is mounted in its typical vertical or hanging position and secured to hoist frame 32 via hoist anchor bracket 35 with anchor pin 37b. To guide chain 26 from hoist 25 to chain wheel 40a, over bag 29, chain wheel 40c is located directly under hoist 25. To prevent chain 26 from coming in contact with bag 29 and or bag lift frame 28, chain wheel 40b is located on hoist frame 34X. Typically, hoist 25 comes from the manufactured pre-wired with a safety switch to stop chain 26 movement as chain hook 39 moves against bottom of hoist 25. Limit switch 38 is mounted to hoist cart 32 under chain wheel 40 so the lifting operation of hoist 25 will stop as chain hook 39 presses against it. Hoist 25 is mounted away from the area under trolley assembly 24 so that bulk bag 29, bag frame 28 can be lifted as close to I-Beam 23 as possible. Chain bag 30 may be secured to hoist 25 to collect chain 26 as hoist 25 is used in the lift mode. Bulk bag 29 may now be made larger to hold a greater capacity and still fit between support tray 85, mounted on cross beam supports 86, and I-Beam 23. To prevent slack in chain 26 from occurring and allowing chain to come off of chain wheels 40a, 40b and 40c, proximity switch 42 mounted on bracket 41 to shut hoist 25 off. It is important to maintain some tension on chain 26 so that it does not become loose and disengage from chain wheels 40a, 40b and 40c.

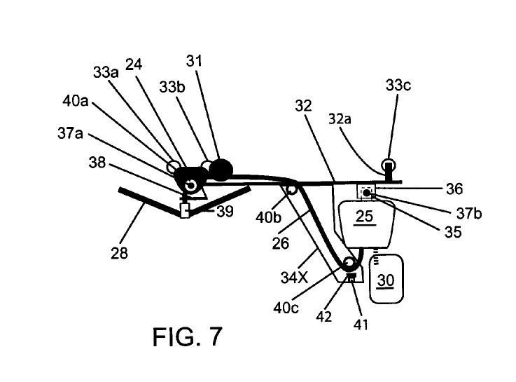

FIG. 7 is a detailed side view of cart 32 and hoist frame 34X shown as a single unit. Hoist 25 is mounted in a vertical position in this view and secured to cart 32 by placing pin 35 through hoist bracket 36 and anchor bracket 35. Hoist 25 is mounted to hoist cart 32 and is located approximately 30″ to the side of chain wheel 40a. Chain wheels 40a, 40b and 40c and hoist 25 are secured to hoist frame 34X and hoist cart 32 so that as trolley assembly 24 and trolley motor 31 moves along I-Beam 23, the distance between chain wheel 40a and hoist 25 is fixed. Switch 42, mounted on flange 41 of hoist frame 34X, ensures that tension in chain 26 is maintained when the bag frame 28 is lowered. If any slack in the chain 26 occurs, switch 42 will detect the slack and shut hoist 25 off.

To prevent bag lift frame from becoming jammed against trolley carriage 24 and causing possible damage to chain wheel 40a and cart frame 32, limit switch 38 monitors movement of bag lift frame 28 and coupler 39 and shuts hoist 25 off when switch 38 is tripped. Trolley cart 32 is moved back and force across I-Beam 23 (not shown) to trolley motor and drive 31. Trolley cart 32 is held onto and allowed to travel along I-Beam 23 (not shown) by trolley wheels 33c, 33a and trolley wheels 33b and 33d (not shown). Trolley wheels 33a, 33b, 33c and 33d are held onto hoist cart 32 by flange supports 32a and 33b, 32c and 32d (not shown.)

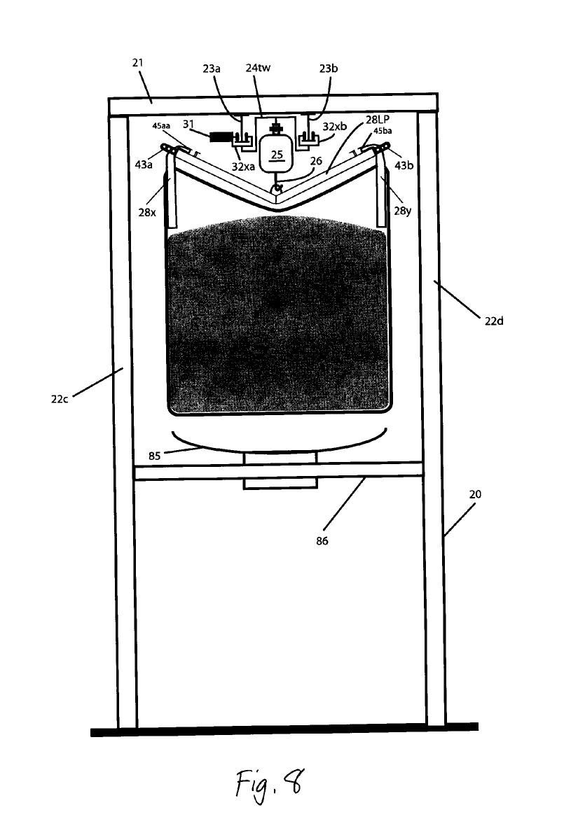

FIG. 8 is a front view of bulk bag unloader 20 with bag 29 raised to its maximum height (within a few inches) under I-Beams 23a and 23b and top frame support 21 by using a hoist carriage 24tw made up of twin I-Beams 23a and 23b and inverted bag lift frame 281p. Hoist carriage assembly 24tw is positioned between I-Beams 23a and 23b so that hoist 25 may be located only a few inches under top frame 21 of unloader 20. Hoist carriage assembly 24tw is equipped with wheel assemblies 32xa and 32xb and trolley motor and drive 31 to move bag 29 back and forth along I-Beams 23a and 23b. Inverted bag lift frame 281p allows bag 29 to be raised higher than standard lift frames by enabling slack in the side walls of bag 29 near its top area, typically long the vertical sides of bag 29 where lifting loops 28X and 28y are attached, so that material in bag maybe positioned directly under (and in contact if necessary) so that bag 29 will clear bag platform 85. Bag lifting loops 28X and 28y of bag 29 may be placed inside of bag frame end flanges 43a and 43b (43c and 43d not shown) so that end of lifting loops 28X and 28y can be secured to posts 45aa and 45ab.

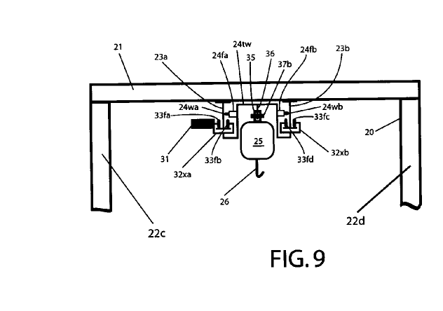

FIG. 9 is a detailed front view of one embodiment of hoist carriage assembly 24tw. Front support posts 22c and 22d of unloader 20 are connected on top by top support 21. I-Beams 23a and 23b may be secured to top support 21 by welding or other fastening means. Hoist 25 is secured hoist frame 24tw by placing hoist pin 37b through flange bracket 36 that is secured to hoist frame 24tw and through hoist bracket 35 that is attached to hoist 25. Wheel support flanges 24fa and 24fb and wheels 24wa and 24wb are secured to the outer vertical wall of hoist frame carriage 24tw to provide linear stability when trolley motor and drive 31 starts and stops. With trolley motor and drive 31 connected to fixture 32xa of I-Beam 23a only, far end of hoist carriage assembly 24tw may jerk towards the inside walls of either I-Beam 23a and 23b and possibly jam or slow its movement when stopping and starting in both directions. Hoist carriage frame 24tw may use cross supports and or gussets (not shown) between in inside vertical walls to provide more stability when hoist 25 is under load. The primary advantage of hoist carriage frame 24tw utilizing two parallel I-Beams 23 and 23b over hoist frame 24 (not shown) is that hoist 25 may be operated without extra chain wheels 40a, 40b and 40c (not shown) and switches 38 (also not shown.)

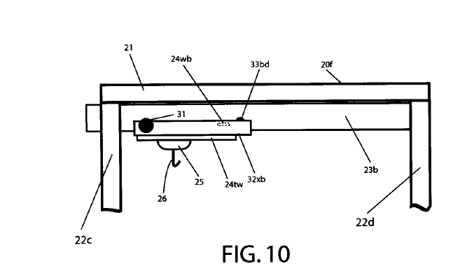

FIG. 10 is a side view of the top section of hoist frame 20f, which may be used to lift bulk bags as well as other loads, with I-Beam 23b secured to top support 21 on front vertical supports 22c and 22d. Hoist frame carriage 24tw is secured to I-Beam 23b by wheel 33fd and wheels 33fa, 33fb, 33fc, 33ba, 33bb, 33bc and 33bd (not shown) Trolley motor and drive 31 is secured to hoist frame carriage 24tw and provides the lateral movement of hoist carriage frame 24tw along I-Beam 23b and 23a (not shown.) I-Beam 23b may be extended beyond vertical support 22c (or support 22d.) Chain 26 extends down from hoist 25. Guide wheel 24wb is shown located at the opposite end of trolley motor and drive 31 on hoist carriage frame 24tw.

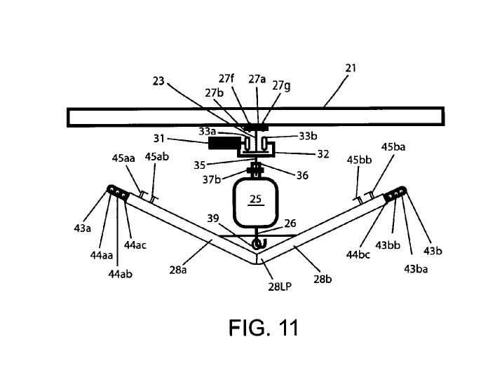

FIG. 11 is a detailed front view of inverted bag lift frame 28LP secured to chain 26 of hoist 25. Chain hook/support bracket 39 is secured between lift arms 28a and 28b of inverted bag frame 28LP. In this configuration, hoist 25 is secured to a standard trolley carriage 32 that is attached to a single I-Beam 23. Inverted bag lift frame 28LP is shown with arms 28a and 28b extending upward from the center of unit where chain 26 is coupled. At the end of arms 28a and 28b, end flanges 43a and 43b are located respectively, to allow adjustment of bag lifting straps (not shown) by placing lock pin 46 (not shown) in one of the holes 44aa, 44ab and 44ac of end flange 43a, and one of the holes 44ba, 44bb and 44bc of end flange 43b. Together with posts 45aa and 45ab of arm 28a and posts 45ba and 45bb of arm 28b, approximately six different points of lifting strap attachment are possible.

Notice that posts 45aa, 45ab, 45ba and 45bb have a perpendicular and horizontal flange on top to keep a bag strap from slipping off.

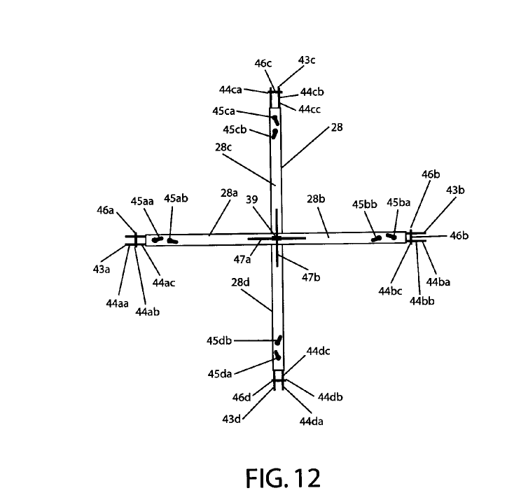

FIG. 12 is a top view of bag frame 28 showing arms 28a, 28b, 28c and 28d. Bracing supports 47a and 47b are placing in the center of bag frame 28 where chain 26 (not shown) will be connected. Posts 45aa and 45ab, 45ba and 45bb, and 45ca and 45cb, and 45da and 45db are located on arms 28a, 28b, 28c and 28d respectively. Notice that top flanges of posts 45aa, 45ab, 45ba, 45bb, 45ca, 45cb, 45da and 45db can be angled slightly off center if desired. Lock pins 46a, 46b, 46c and 46d may be located holes 44aa, 44ab, 44ac, 44ba, 44bb, 44bc, 44ca, 44cb, 44cc, 44da, 44db or 44dc of end flanges 43a, 43b, 43c and 43d respectively to provide for adjustment of bag lifting loops 28v, 28w, 28X and 28y (not shown). Lock pins may also be used to hold snap rings 48a, 48b, 48c and 48d (also not shown.)

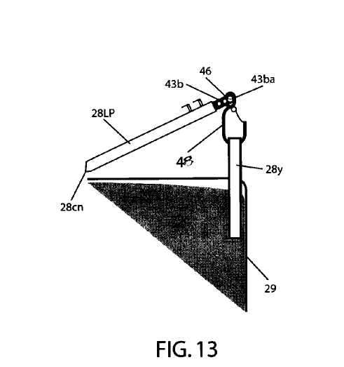

FIG. 13 is a detailed front view of one arm of inverted bag frame 28LP equipped with snap ring 48. Snap ring 48 is secured to inverted bag frame 28LP by placing lock pin 46 through hole 43ba of end flange 43b. Because inverted bag frame 28LP may have a difference in height of more than 8″ between its center chain coupling area and the end flanges, a snap ring may be required to hold the straps of completely full bags of material (incapable of being raised upward using slack on the sidewall of the bag) since the average length of bag lifting loops straps is 10″.

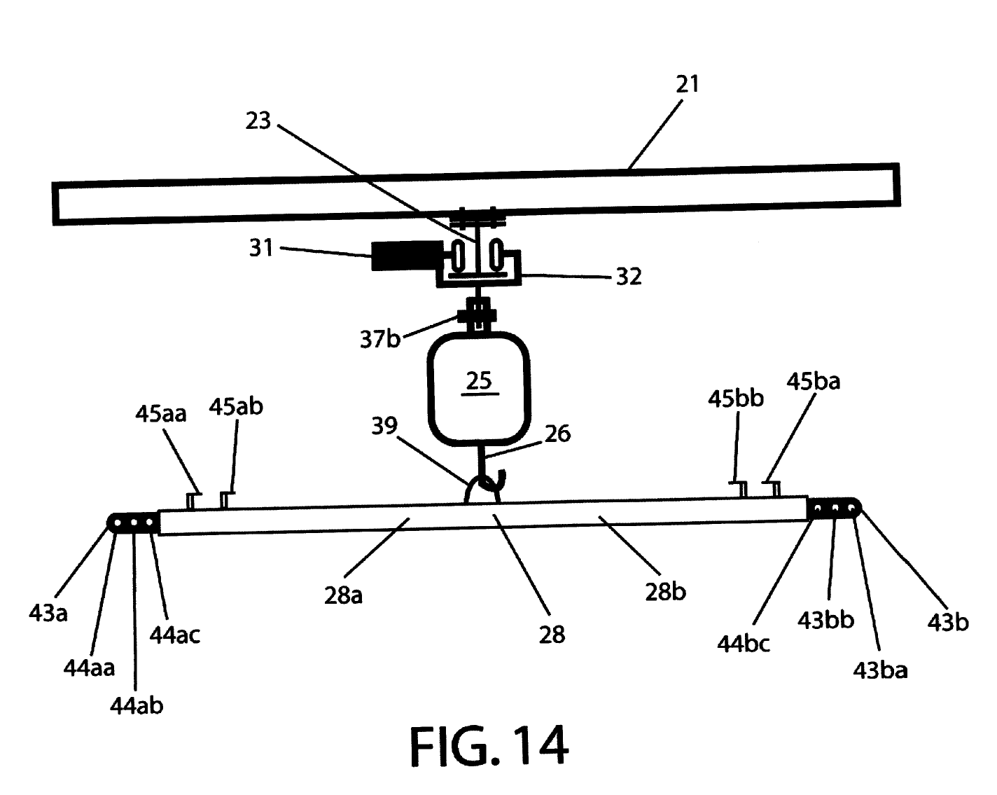

FIG. 14 is a detailed front view of bag lift frame 28 that is secured to chain 26 of hoist 25 on trolley carriage 32. In this configuration, bag lift frame 28 is horizontal and not inverted but retains the same adjustment components such as posts 45aa, 45ab, 45ac and 45ad in conjunction with holes 44aa, 44ab, and 44ac of end flange 43a and holes 44ba, 44bb and 44bc of end flange 43b.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

1. A low-headroom lifting apparatus comprising:
an unloader frame adapted to support the weight of an object to be lifted and having a top frame support at the top of the unloader frame;
at least one I-beam this is at least as long as the top frame support and is adapted to be secured to the unloader frame under the top frame support; and
a trolley assembly adapted to be in communication with each I-beam, the trolley assembly comprising:
a hoist frame;
rolling means attached to the hoist frame adapted for translating the trolley assembly along the I-beam; and
a hoist secured to the hoist frame and selected to lift the weight of an object to be lifted by a tension-bearing element.

2. The apparatus of claim 1, further comprising a support tray attached to the unloader frame below the trolley assembly, the support tray being adapted to receive an object to be lifted.

3. The apparatus of claim 1, further comprising a bag frame, the bag frame comprising:
a plurality of attachment points at its perimeter adapted to attach to an object to be lifted, and
a central lifting means adapted to be secured to the tension-bearing element.

4. The apparatus of claim 3, wherein the bag frame is adapted so that the attachment points are higher than the central lifting means when the bag frame is in use, thereby enabling the apparatus to lift an object with lower headroom.

5. The apparatus of claim 4, wherein the attachment points are arms extending from the central lifting means, the arms comprising:
end flanges adapted to receive locking pins, thereby allowing adjustment of the arm lengths; and
posts adapted to receive attachment means of an object to be lifted.

6. The apparatus of claim 5, wherein the central support means is a chain hook support bracket.

7. The apparatus of claim 1, wherein the I-beam is secured to the unloader frame by welding or bolting.

8. The apparatus of claim 1, wherein the tension-bearing means is one taken from the group consisting of chain, cable, rope, strapping, and wire rope.

9. The apparatus of claim 1 further comprising a first chain wheel rotatably secured near an end of the hoist frame, said hoist being secured in a substantially horizontal position near an end of the hoist frame opposite the chain wheel, thereby enabling an object to be lifted higher than the hoist.

10. The apparatus of claim 3, further comprising a limit switch in communication with the hoist, the limit switch attached to the hoist frame and adapted to detect the presence of the bag frame and shut down the hoist.

11. The apparatus of claim 1, further comprising a chain bag attached to the hoist frame adapted to receive portions of the tension-bearing element that have passed through the hoist.

12. The apparatus of claim 1, further comprising a trolley motor secured to the hoist frame, the trolley motor adapted to translate the trolley assembly along the I-beam using a rolling means.

13. The apparatus of claim 1, further comprising a hoist cart adapted to be secured to the trolley assembly.

14. The apparatus of claim 13, the hoist cart comprising:
rolling means adapted for translating the hoist cart along the I-beam;
a hoist frame to which the rolling means are secured;
a hoist frame flange secured to the hoist frame and adapted for supporting the hoist in a substantially horizontal position, and
a hoist anchor bracket attached to the hoist frame for securing the hoist to the hoist cart, thereby preventing the hoist from rotating when tension on the tension-bearing element is released.

15. The apparatus of claim 13, the hoist cart comprising:
rolling means adapted for translating the hoist cart along the I-beam;
a hoist frame to which the rolling means are secured;
a hoist frame flange secured to the hoist frame; and
a hoist anchor bracket attached to the hoist frame for securing the hoist to the hoist cart and adapted for supporting the hoist in a substantially horizontal position.

16. The apparatus of claim 15, further comprising a second chain wheel rotatably secured to the hoist frame under the hoist to guide the tension-bearing element.

17. The apparatus of claim 16, further comprising a third chain wheel rotatably positioned on the hoist frame to guide the tension-bearing element and to prevent the tension-bearing element from coming into contact with an object to be lifted.

18. The apparatus of claim 16, further comprising a proximity switch in communication with the hoist secured to the hoist frame beneath the second chain wheel and adapted to detect the tension-bearing element losing contact with the second chain wheel.

19. The apparatus of claim 14, wherein two I-beams are adapted to be secured to the unloader frame under the top frame support in a parallel relationship spaced apart at least the width of the hoist, the hoist frame adapted to elevate the hoist between the two I-beams, thereby enabling the hoist to lift the object to be lifted higher than with a single I-beam.

20. The apparatus of claim 1, wherein the rolling means are wheels.

21. The apparatus of claim 12, wherein the trolley motor translates the trolley assembly by applying force to the rolling means.
